(19) United States
(12) Patent Application Publication
(10) Pub. No.: US 2025/0220773 A1
(43) Pub. Date: Jul. 3, 2025

(54) COMMUNICATION METHOD AND USER EQUIPMENT

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/065,503

(22) Filed: Feb. 27, 2025

Related U.S. Application Data
(63) Continuation of application No. PCT/JP2023/032056, filed on Sep. 1, 2023.
(60) Provisional application No. 63/403,024, filed on Sep. 1, 2022.

(51) Int. Cl. H04W 76/40; H04L 12/18; H04W 4/06

(52) U.S. Cl. CPC H04W 76/40; H04L 12/189; H04W 4/06

(57) ABSTRACT

A communication method used in a mobile communication system includes transmitting, by a first user equipment existing in a first cell, a request signal for requesting provision of broadcast control information to be broadcast in a second cell adjacent to the first cell to a predetermined apparatus. The predetermined apparatus is a second user equipment existing in the second cell, a first base station managing the first cell, or a second base station managing the second cell.

### RELATED APPLICATIONS

The present application is a continuation based on PCT Application No. PCT/JP2023/032056, filed on Sep. 1, 2023, which claims the benefit of U.S. Provisional Patent Application No. 63/403,024 filed on Sep. 1, 2022. The content of which is incorporated by reference herein in their entirety.

### TECHNICAL FIELD

The present disclosure relates to a communication method and a user equipment used in a mobile communication system.

### BACKGROUND

The 3rd Generation Partnership Project (3GPP) has defined the technical specifications of New Radio (NR) that is radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR (for example, see Non-Patent Document 1).

### CITATION LIST

### Non-Patent Literature

Non-Patent Document 1: 3GPP Technical Specification: TS 38.300 V17.1.0

### SUMMARY

In a first aspect, a communication method is used in a mobile communication system, the communication method including transmitting, by a first user equipment existing in a first cell, a request signal for requesting provision of broadcast control information to be broadcast in a second cell adjacent to the first cell to a predetermined apparatus. The predetermined apparatus is a second user equipment existing in the second cell, a first base station managing the first cell, or a second base station managing the second cell.

In a second aspect, a user equipment is used in a mobile communication system, the user equipment including a transmitter configured to transmit, by the user equipment, a request signal for requesting provision of broadcast control information to be broadcast in a second cell adjacent to the first cell to a predetermined apparatus when the user equipment exists in a first cell. The predetermined apparatus is another user equipment existing in the second cell, a first base station managing the first cell, or a second base station managing the second cell.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a flowchart illustrating an operation example of the mobile communication system with respect to MBS broadcast reception according to an embodiment.

FIG. 7 is a diagram for describing an operation scenario for the mobile communication system according to an embodiment.

FIG. 8 is a diagram for describing a first operation pattern.

FIG. 9 is a flowchart illustrating an operation flow example of the first operation pattern.

FIG. 10 is a diagram for describing a second operation pattern.

FIG. 11 is a flowchart illustrating an operation flow example of the second operation pattern.

FIG. 12 is a diagram for describing a third operation pattern.

FIG. 13 is a flowchart illustrating an operation flow example of the third operation pattern.

FIG. 14 is a diagram for describing a fourth operation pattern.

FIG. 15 is a flowchart illustrating an operation flow example of the fourth operation pattern.

### DESCRIPTION OF EMBODIMENTS

A mobile communication system according to an embodiment is described with reference to the drawings. In the description of the drawings, the same or similar parts are denoted by the same or similar reference signs.

### (1) Configuration of Mobile Communication System

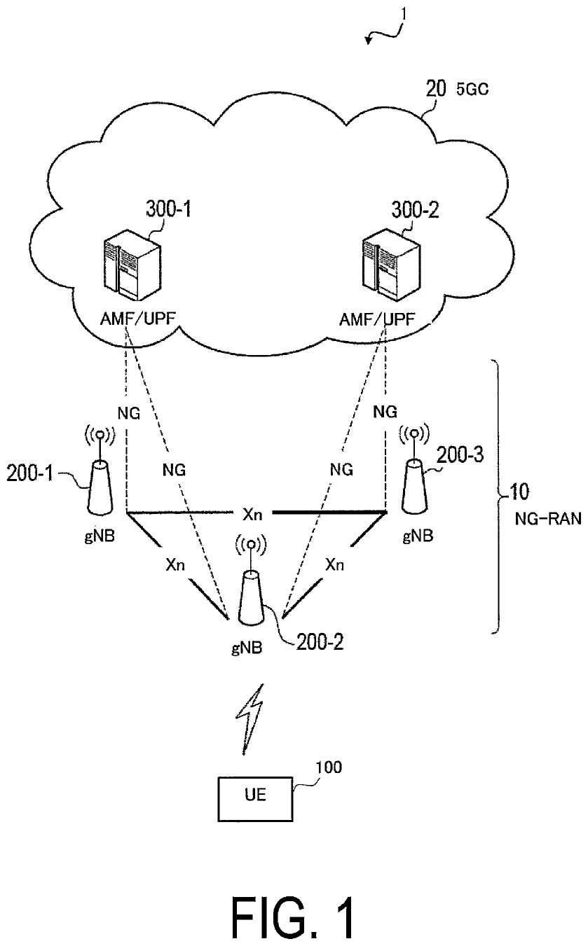

FIG. 1 is a diagram illustrating a configuration of a mobile communication system according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10 (a network 10). The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (vehicle UE), and a flying object or an apparatus provided on a flying object (aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

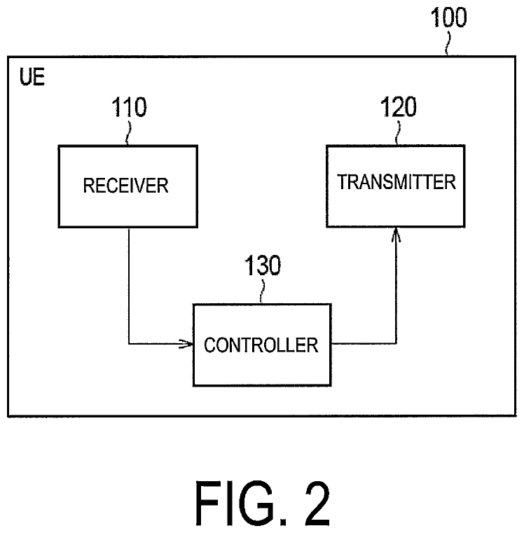

FIG. 2 is a diagram illustrating a configuration of the UE 100 (user equipment) according to an embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

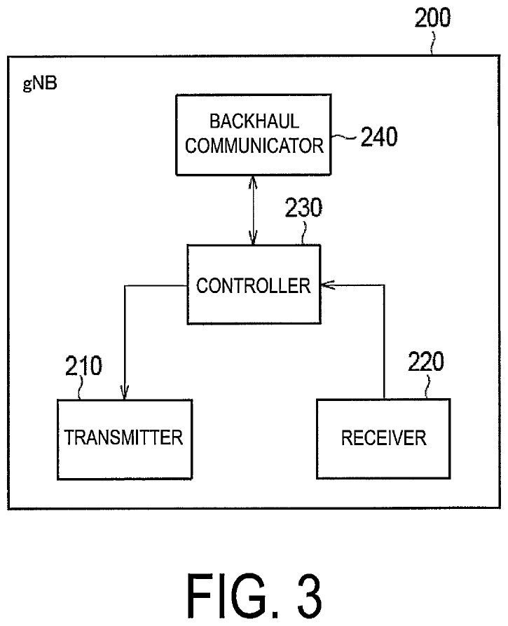

FIG. 3 is a diagram illustrating a configuration of the gNB 200 (base station) according to an embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

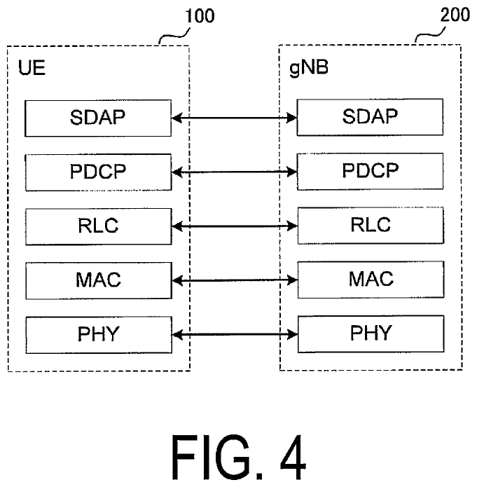

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

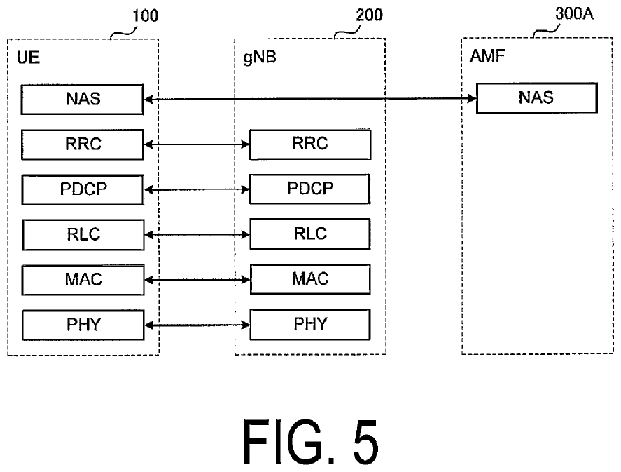

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection is present between the RRC of the UE 100 and the RRC of the gNB 200 (RRC connection), the UE 100 is in an RRC connected state. When no connection is present between the RRC of the UE 100 and the RRC of the gNB 200 (RRC connection), the UE 100 is in an RRC idle state. When the connection between the RRC of the UE 100 and the RRC of the gNB 200 is suspended, the UE 100 is in an RRC inactive state.

The NAS layer that is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### (2) Overview of MBS

The mobile communication system 1 can perform delivery with high resource efficiency by using the multicast/broadcast service (MBS).

In the broadcast communication services (also referred to as “MBS broadcast”), the same service and the same specific content data are provided simultaneously to every UE 100 within a geographic area. That is, every UE 100 in the broadcast service area is allowed to receive the data. The broadcast communication services are delivered to the UE 100 using a broadcast session, which is a type of MBS session. The UE 100 can receive the broadcast communication services in any state of the RRC idle state, the RRC inactive state, and the RRC connected state. Such a delivery mode may also be referred to as “delivery mode 2”.

In a multicast communication service (also referred to as “MBS multicast”), the same service and the same specific content data are simultaneously provided to a specific UE set. That is, not every UE 100 in the multicast service area is allowed to receive data. The multicast communication services are delivered to the UE 100 using a multicast session, which is a type of MBS session. The UE 100 can receive the multicast communication services in the RRC connected state using mechanisms such as Point-to-Point (PTP) and/or Point-to-Multipoint (PTM) delivery. The UE 100 may receive the multicast communication services in the RRC inactive (or RRC idle) state. Such a delivery mode may also be referred to as “delivery mode 1”.

Main logical channels used for MBS delivery are a multicast traffic channel (MTCH), a dedicated traffic channel (DTCH), and a multicast control channel (MCCH). The MTCH is a PTM downlink channel for transmitting MBS data of either multicast or broadcast sessions from the network 10 to the UE 100. The DTCH is a PTP channel for transmitting MBS data of a multicast session from the network 10 to the UE 100. The MCCH is a PTM downlink channel for transmitting MBS broadcast control information associated with one or more MTCHs from the network 10 to the UE 100. The downlink control channel (DCCH) is also used in the configuration (RRC Reconfiguration) in the delivery mode 1.

Regarding a configuration in MBS broadcast, the UE 100 in the RRC idle state, the RRC inactive state, or the RRC connected state receives an MBS configuration for a broadcast session (e.g., parameters required for MTCH reception) via the MCCH. Parameters required for reception of the MCCH (MCCH configuration) are provided through system information. In particular, system information block type 20 (SIB20) includes the MCCH configuration. Note that system information block type 21 (SIB21) includes information related to service continuity of MBS broadcast reception. The MCCH provides a list of all broadcast services including ongoing sessions transmitted on the MTCH, and the related information of the broadcast session includes an MBS session ID (e.g., Temporary Mobile Group Identity (TMGI)), related G-RNTI scheduling information, and information about neighboring cells providing a specific service on the MTCH.

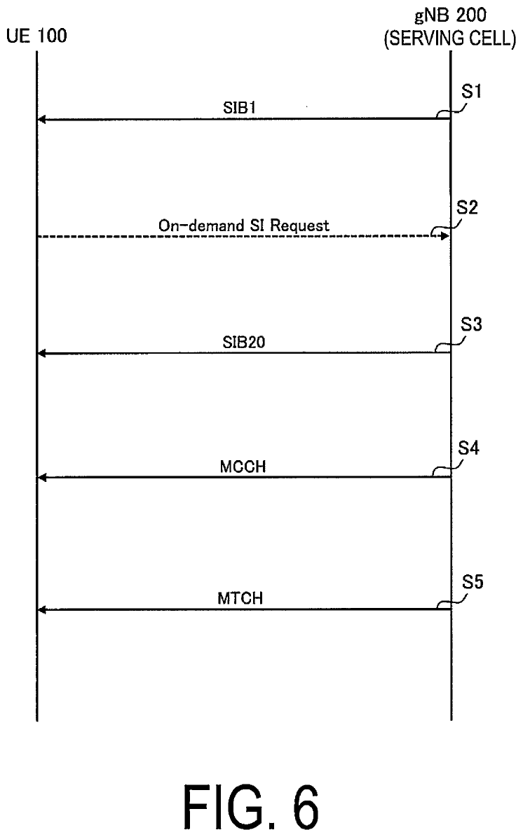

FIG. 6 is a flowchart illustrating an operation example of the mobile communication system 1 with respect to MBS broadcast reception according to an embodiment. The UE 100 exists in a cell of the gNB 200 and selects the cell as a serving cell. “Existing in a cell” means that the UE 100 selects the cell as serving cell, and the UE 100 may be in any RRC state (RRC idle state, RRC inactive state, or RRC connected state). “Existing” is also referred to as “camping”. A scenario in which the UE 100 is in the RRC idle state or the RRC inactive state will be mainly described below.

In step S1, the UE 100 receives system information block type 1 (SIB1) from the gNB 200. The system information (SI) includes a master information block (MIB) and several system information blocks (SIBs), and is divided into minimum SI and other SI. The SI message is mapped to a broadcast control channel (BCCH) and is dynamically carried on a downlink shared channel (DL-SCH). Scheduling of other SI is indicated in SIB1.

The minimum SI includes basic information necessary for initial access and information for obtaining other SI. The minimum SI includes SIB1. SIB1 defines scheduling of other system information blocks and includes information necessary for initial access. SIB1 is also referred to as a RemainingMinimumSI (RMSI) and is periodically broadcast or transmitted to the UE 100 in the RRC connected state in a dedicated manner.

The other SI includes all SIBs that are not broadcast in the minimum SI. These SIBs are broadcast periodically or broadcast on demand in response to a request from the UE 100 in the RRC idle state, the RRC inactive state, or the RRC connected state. Note that the other SI may be transmitted to the UE in the RRC connected state by using a dedicated method on the DL-SCH. Other SI includes SIB20.

Scheduling information (SI Scheduling Info) in SIB1 indicates whether other SI is being broadcast. When SIB1 indicates that SIB20 has not been broadcast, the UE 100 that wishes to obtain SIB20 transmits an On-demand SI Request for requesting transmission of SIB20 to the gNB 200 (step S2).

Here, for the UE 100 in the RRC idle state and the RRC inactive state, other SI requests (On-demand SI Request) trigger a random access procedure. In this case, MSG1 (i.e., random access preamble) is used to indicate the requested other SI. When MSG1 is used, the minimum granularity of the request is one SI message (i.e., a set of SIBs) and one RACH preamble and/or PRACH resource can be used to request multiple SI messages.

Note that, when the UE 100 of the RRC connected state is configured by a network, a request for other SI can be transmitted to the network by using a dedicated method (to be specific, by using dedicated signalling via the UL-DCCH). The gNB 200 responds with an RRC Reconfiguration message including the requested SIB. The network determines which requested SIB is to be delivered, either exclusively or by broadcasting.

In step S3, the UE 100 receives SIB20 from the gNB 200 and obtains the configuration information of the MCCH included in SIB20.

In step S4, the UE 100 receives the MCCH from the gNB 200 according to SIB20 of step S3, and obtains the MBS broadcast control information carried on the MCCH.

In step S5, the UE 100 receives the MTCH from the gNB 200 according to the MCCH of step S4, and obtains the MBS broadcast data carried on the MTCH.

### (3) Operation of Mobile Communication System

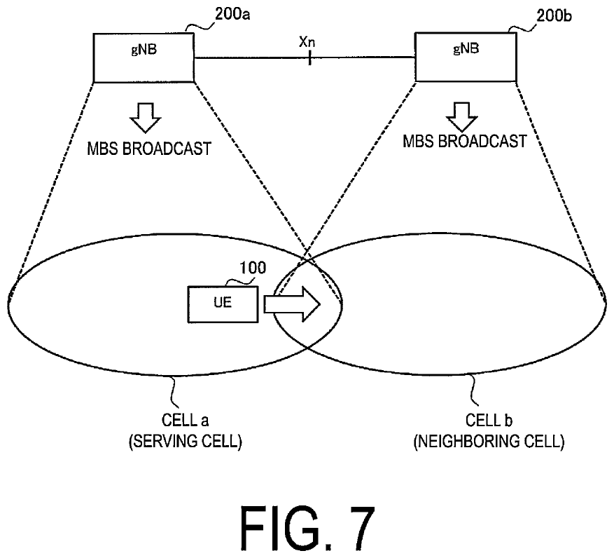

FIG. 7 is a diagram for describing an operation scenario for the mobile communication system 1 according to an embodiment. In the illustrated example, a cell a (first cell) is managed by a gNB 200a (first base station), and a cell b (second cell) adjacent to the cell a is managed by a gNB 200b (second base station). However, the cell a and the cell b may be managed by one gNB 200.

The UE 100 (first user equipment) existing in the cell a receives MBS broadcast of the cell a. The UE 100 is assumed to be moving in the direction of the cell b and want to continue receiving the MBS broadcast even in the cell b. In this case, the UE 100 obtains SIB20 from the cell b when switching from the cell a to the cell b (cell reselection or handover), receives the MCCH from the cell b based on corresponding SIB20, and then becomes able to receive the MTCH. For this reason, a problem that the movement of the UE 100 causes MBS reception interruption (service interruption) arises.

Other SI (Other SI) may include SIB20 and the cell b may not broadcast SIB20. When the cell b is not broadcasting SIB20, the UE 100 needs to request SIB20 with an On-demand SI Request (i.e., PRACH or dedicated signaling), which further extends the service interruption time.

The embodiment enables the UE 100 to obtain SIB20 and/or the MCCH (hereinafter also referred to as “SIB20/MCCH”) of the cell b at an earlier stage to reduce the service interruption time.

To be more specific, a UE 100a existing in the cell a transmits a request signal for requesting provision of broadcast control information to be broadcast in the cell b adjacent to the cell a to a predetermined apparatus. The predetermined apparatus is another UE 100 (second user equipment) existing in the cell b, a gNB 200a managing the cell a, or a gNB 200b managing the cell b. Thus, the UE 100a can obtain the broadcast control information directly or indirectly from the gNB 200b while existing in the cell a.

The broadcast control information includes on-demand system information (i.e., other SI) that is broadcast in response to a request from the UE 100. In an embodiment, the broadcast control information includes a message transmitted on the MCCH of the cell b (MBS broadcast control information) and/or a system information block indicating the configuration of the MCCH (i.e., SIB20).

### (3.1) First Operation Pattern

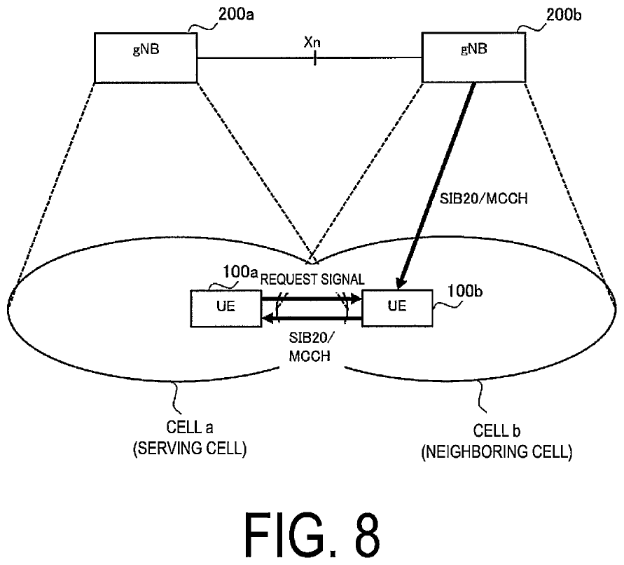

A first operation pattern of the mobile communication system 1 according to an embodiment will be described. FIG. 8 is a diagram for describing the first operation pattern.

In the first operation pattern, the predetermined apparatus is another UE 100b (second user equipment) existing in the cell b. The UE 100a (first user equipment) transmits a request signal for requesting provision of the broadcast control information to be broadcast in the cell b to the UE 100b on sidelink. In the first operation pattern, the request signal is a transfer request message for requesting transfer of the broadcast control information.

The request signal (transfer request message) may include information indicating an MBS service of interest to the UE 100a. The request signal (transfer request message) may include information identifying a cell of interest to the UE 100a and/or information identifying broadcast information of interest to the UE 100a. The request signal (transfer request message) may include information for requesting transfer of the MCCH (MBS broadcast control information) without transferring SIB20 (MCCH configuration information).

The UE 100b having received the request signal (transfer request message) may request the cell b to transmit SIB20. The UE 100b receives the broadcast control information of the cell b. In response to receiving the request signal (transfer request message), the UE 100b transfers the broadcast control information to the UE 100a on sidelink.

The UE 100a may transmit a query to the UE 100b, the query regarding the MBS service that cell b is providing.

The UE 100b may transmit a discovery message on sidelink, the discovery message including at least one of information about the capability to transfer the broadcast control information or information indicating the MBS service that the cell b is providing. The UE 100a may receive the discovery message.

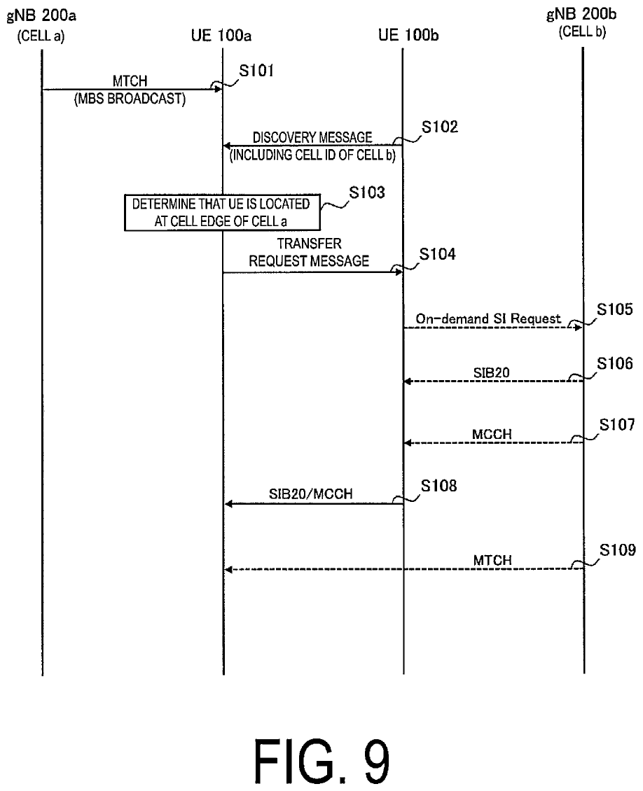

FIG. 9 is a flowchart illustrating an operation flow example of the first operation pattern. The UE 100a existing in the cell a is receiving MBS broadcast data on the MTCH of the cell a (step S101). The UE 100a may be an RRC idle state or an RRC inactive state in the cell a.

In step S102, the UE 100b broadcasts a discovery message (in particular, a Model A discovery message) including the cell ID of the cell b on sidelink. The message may include information indicating that the UE 100b has an SIB20/MCCH transfer capability (to permit a transfer request) and/or information (TMGI, etc.) of the MBS service that the cell b provides. The message may further include a neighboring UE list. The neighbor UE list includes information indicating which UE 100 is existing in which cell. The neighbor UE list is used by the UE 100a to specify to which UE 100 transfer is requested while moving to a cell.

In step S103, the UE 100a determines that the UE itself is located at a cell edge of the cell a (performs cell reselection), specifies the cell b, and recognizes that the SIB20/MCCH of the cell b is necessary. Based on the discovery message of step S102, the UE 100a recognizes that the UE 100b exists in the cell b.

In step S104, the UE 100a transmits a SIB20/MCCH transfer request to the UE 100b. Here, when the UE 100a and the UE 100b are in a PC5-Connected state (i.e., when a PC5 connection is present), the UE 100a may transmit the transfer request through a PC5-RRC message or a PC5-S message. On the other hand, when no PC5 connection is present between the UE 100a and the UE 100b, the UE 100a may transmit the transfer request in a Model A discovery message or a Model B discovery message.

The UE 100a may establish a PC5 connection with the UE 100b by recognizing that the UE 100b is existing in the cell b. For example, the UE 100a transmits Direct Communication Request (PC5-S) or RRC Reconfiguration Sidelink (PC5-RRC) to the UE 100b as a connection request message, and establishes a PC5 connection with the UE 100b. The connection request message may include information indicating that the message is a connection request for only SIB20/MCCH transfer, for example, as a cause value. The UE 100b may use the information to determine whether to accept the connection request.

The transfer request message of step S104 may include at least one of the information below including:
a query about MBS service information (TMGI, etc.) that the cell b provides;
MBS service information (TMGI, etc.) of interest to the UE 100a;
cell IDs of interest to the UE 100a (especially for the case in which no cell IDs are broadcast in discovery in step S102;
the number of the SIB of interest to (or desired to be transferred by) the UE 100a (in particular SIB20, etc.); and
information indicating that the UE 100a wishes to transfer the MCCH (since the MTCH can be received when only the MCCH information is present, and SIB20 does not need to be obtained).

The UE 100b receives the transfer request message from the UE 100a. When the UE 100b has already obtained the SIB20/MCCH of the cell b, the UE 100b transfers the SIB20/MCCH to the UE 100a on sidelink (step S108).

On the other hand, when the UE 100b has not obtained the SIB20/MCCH of the cell b, the UE 100b transmits an on-demand SI request to the cell b in step S105. Accordingly, in steps S106 and S107, the UE 100b obtains the SIB20/MCCH from the cell b. Here, the UE 100b transmits a PRACH-based on-demand SI request when the UE itself is in the RRC idle state or the RRC inactive state, and transmits a dedicated signaling-based on-demand SI request when the UE itself is in the RRC connected state.

In step S108, the UE 100b transfers the obtained SIB20/MCCH to the UE 100a on sidelink. For example, the UE 100b may encapsulate the obtained SIB20/MCCH in any one of a Model A discovery message, a Model B discovery message (Response), and a PC5-RRC message and transmit the encapsulated message to the UE 100a.

In step S109, the UE 100a receives the MTCH (MBS broadcast data) of the cell b based on the SIB20/MCCH transferred in step S108.

Note that, in response to the on-demand SI request of step S105, the cell b starts broadcasting of SIB20. When the UE 100a can directly receive SIB20 of the cell b, the UE may obtain corresponding SIB20 directly from the cell b. In that case, SIB20 does not need to be transferred on sidelink of step S108.

### (3.2) Second Operation Pattern

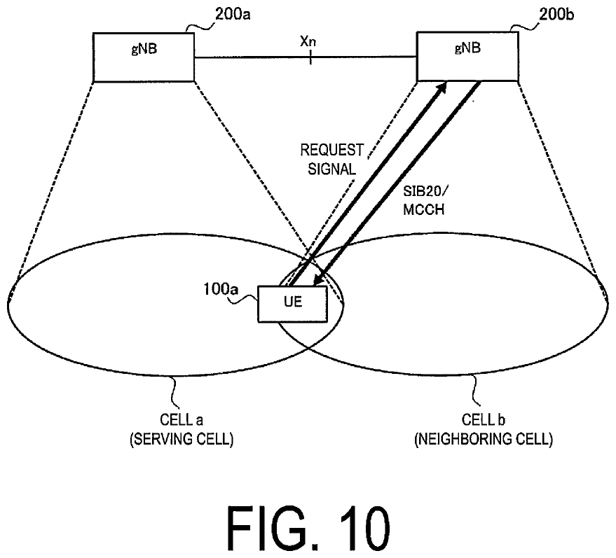

Differences of a second operation pattern of the mobile communication system 1 according to the embodiment from the above-described first operation pattern will be mainly described. FIG. 10 is a diagram for describing a second operation pattern.

In the second operation pattern, a predetermined apparatus is a gNB 200b that manages the cell b. The UE 100a existing in the cell a transmits a request signal for requesting provision of broadcast control information to be broadcast in the cell b directly to the gNB 200b. The UE 100a directly receives the broadcast control information to be broadcast in the cell b.

In the second operation pattern, the gNB 200a may broadcast, in the cell a, information indicating whether to permit transmission of the request signal to the cell b. The UE 100a may transmit the request signal to the gNB 200b in response to the information indicating that the transmission of the request signal is permitted to the cell b.

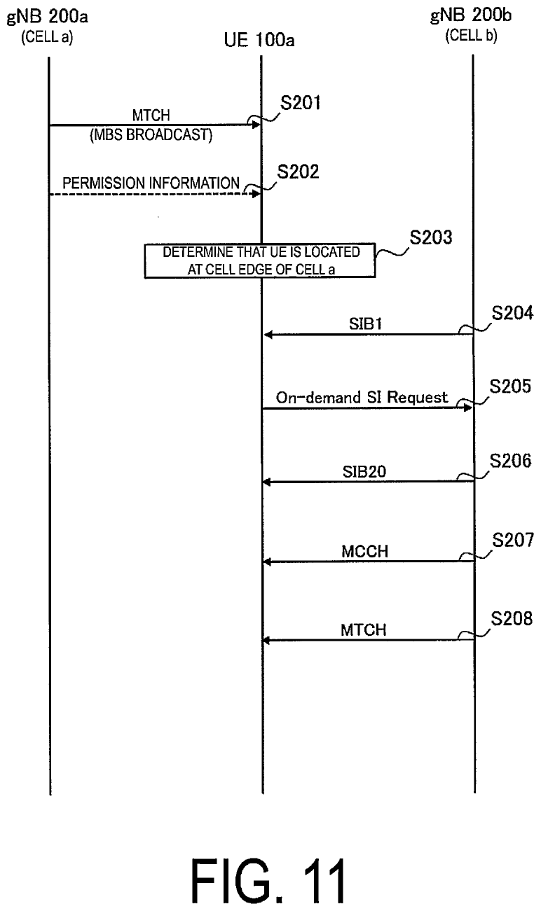

FIG. 11 is a flowchart illustrating an operation flow example of the second operation pattern. The UE 100a existing in the cell a is receiving MBS broadcast data on the MTCH of the cell a (step S201).

In step S202, the gNB 200a (cell a) may broadcast information on whether the UE 100a may transmit an On-demand SI Request directly to the cell b. The information may include (a list of) cell IDs of neighboring cells in which transmission of the On-demand SI Request is permitted or not permitted.

In step S203, the UE 100a recognizes that the UE itself is located at a cell edge of the cell a (immediately before cell reselection), and recognizes that the UE needs to obtain the SIB20/MCCH of the cell b. The UE 100a synchronizes with the cell b while existing in the cell a.

In step S204, the UE 100a obtains SIB1 from the cell b. When SIB20 is “notBroadcasted” in SI Scheduling Info in SIB1, the UE 100a determines to transmit an On-demand SI Request to the cell b. Note that, the SIB1 may include information indicating whether a UE 100 existing in a cell other than the cell b is permitted to transmit an On-demand SI Request to the cell b.

The UE 100a obtains system frame number (SFN) information of the cell b and PRACH resource information of the cell b allocated to the On-demand SI Request from the cell b. To be more specific, the UE 100a obtains the PRACH resource information for the On-demand SI Request from SI RequestConfig in SI Scheduling Info. The RRC of the UE 100a notifies its own MAC of the PRACH resource information, and instructs its own MAC to transmit the PRACH for the On-demand SI Request to the cell b. Here, the RRC of the UE 100a may also notify its own MACs that the PRACH resource configuration is temporary. The MAC of the UE 100a retains the current configuration (configuration of the cell a) and apply the temporary configuration of the cell b. Note that these pieces of information are applied only to transmission of the On-demand SI Request. The MAC of the UE 100a may discard the PRACH resource information of the cell b after the PRACH transmission for cell reselection (step S205) and apply the retained configuration of the cell a again.

In step S205, the UE 100a transmits an On-demand SI Request to the cell b.

In step S206, the UE 100a obtains SIB20 from the cell b.

In step S207, the UE 100a obtains the MCCH from the cell b.

In step S208, the UE 100a obtains the MTCH (MBS broadcast data) from the cell b.

### (3.3) Third Operation Pattern

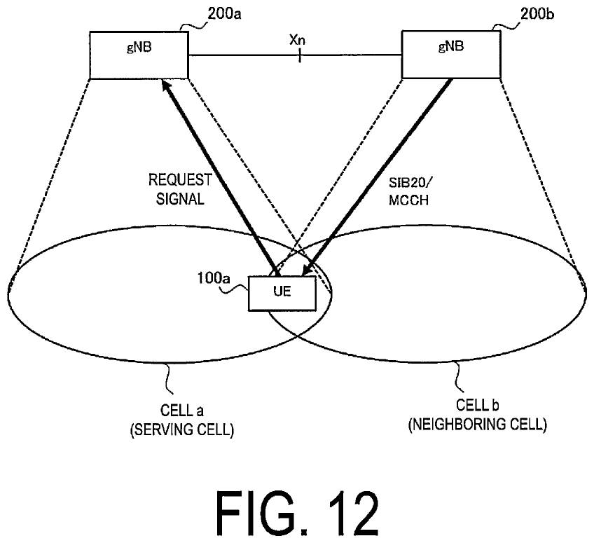

Differences of a third operation pattern of the mobile communication system 1 according to the embodiment from the above-described first and second operation patterns will be mainly described. FIG. 12 is a diagram for describing the third operation pattern.

In the third operation pattern, a predetermined apparatus is the gNB 200a. The UE 100a transmits a request signal for requesting provision of broadcast control information to be broadcast in the cell b to the gNB 200a (cell a). The request signal may be a signal for requesting start of broadcasting of broadcast control information by the cell b. The gNB 200a having received the request signal requests the gNB 200b to start transmission of the broadcast control information. The UE 100a receives the broadcast control information from the cell b.

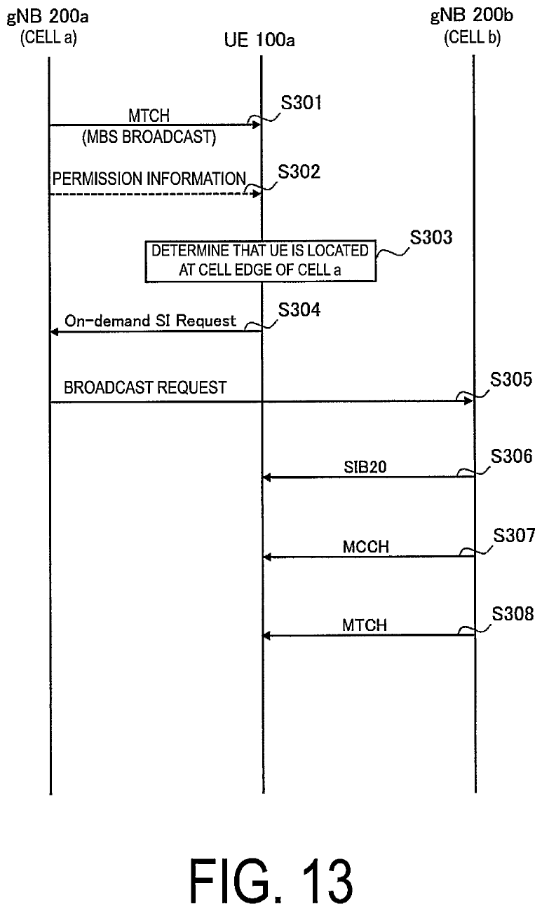

FIG. 13 is a flowchart illustrating an operation flow example of the third operation pattern. The UE 100a existing in the cell a is receiving MBS broadcast data on the MTCH of the cell a (step S301).

In step S302, the gNB 200a (cell a) may broadcast information indicating whether to permit transmission of the On-demand SI Request for the cell b. The gNB 200a may broadcast the information in an SIB. The gNB 200a may broadcast the information on the MCCH. Alternatively, the gNB 200a (cell a) may broadcast information indicating whether the cell b is broadcasting SIB20. The gNB 200a (cell a) may broadcast the PRACH resource of the cell a allocated to the On-demand SI Request for the cell b. Note that it is assumed that the PRACH resource is a resource different from the PRACH resource allocated to the existing On-demand SI Request.

In step S303, the UE 100a recognizes that the UE itself is located at a cell edge of the cell a (immediately before cell reselection).

In step S304, the UE 100a transmits an On-demand SI Request for the cell b to the cell a. The On-demand SI Request may be associated with (for example, may include) at least one of the information below including:
information indicating whether to request SIB20 broadcast in the cell a (the same as and/or similar to before) or to request SIB20 broadcast in the cell b;
the cell ID of the cell requesting SIB20 broadcast (in the illustrated example, the cell ID of the cell b); and
information indicating which SIB is required (SIB number).

The UE 100a may notify the gNB 200a of these pieces of information by dividing the PRACH resource and associating the information with each resource. A dedicated SI request may include these pieces of information as an IE.

In step S305, the gNB 200a requests the gNB 200b to start the SIB20 broadcast of the cell b. This request may be transmitted in a message transmitted on an Xn interface (inter-base station interface). The request may be transmitted in a message transmitted on an NG interface (i.e., via the AMF). The message of step S305 may include the information reported in the On-demand SI Request of step S304.

In step S306, the gNB 200b starts broadcasting of SIB20 in the cell b in response to receiving the message of step S305. The UE 100a obtains corresponding SIB20.

In step S307, the UE 100a obtains the MCCH from the cell b.

In step S308, the UE 100a obtains the MTCH (MBS broadcast data) from the cell b.

### (3.4) Fourth Operation Pattern

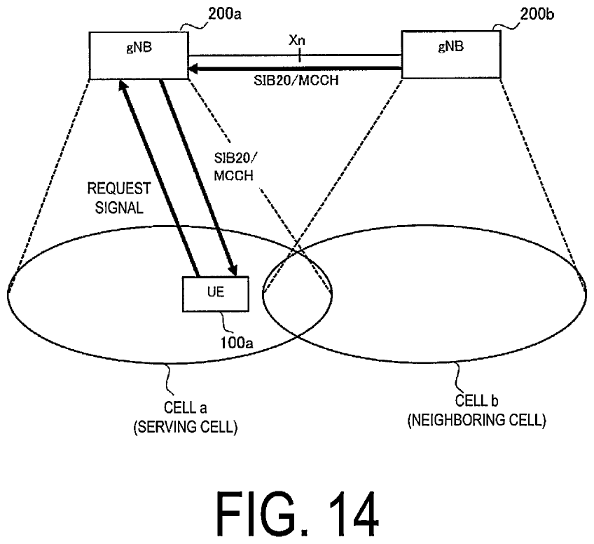

Differences of a fourth operation pattern of the mobile communication system 1 according to the embodiment from the above-described first to third operation patterns will be mainly described. The fourth operation pattern is an operation pattern obtained by partially changing the above-described third operation pattern. FIG. 14 is a diagram for describing the fourth operation pattern.

In the fourth operation pattern, the UE 100a transmits, to the gNB 200a (cell a), a request signal for requesting broadcast control information to be obtained from the gNB 200b (cell b) via the gNB 200a (cell a). The UE 100a receives the broadcast control information from the gNB 200a.

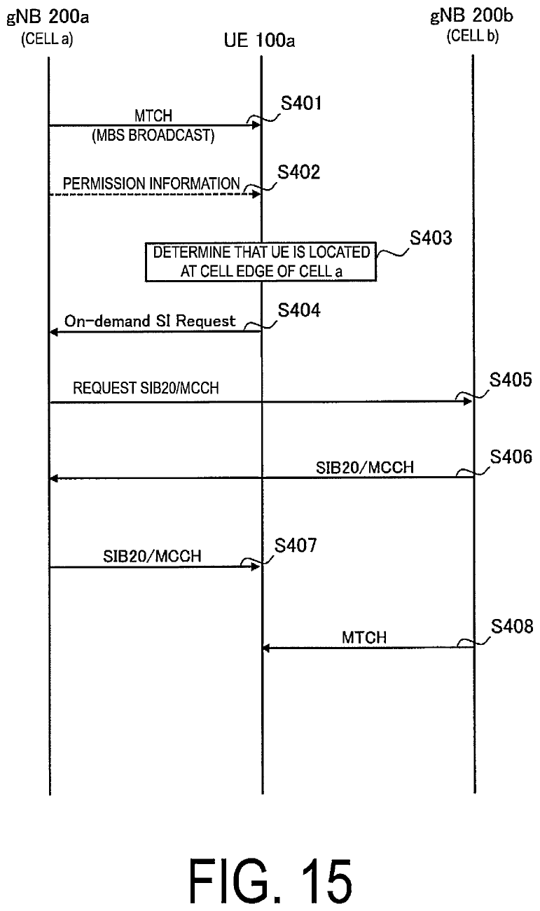

FIG. 15 is a flowchart illustrating an operation flow example of the fourth operation pattern. The operations from step S401 to step S404 are the same as and/or similar to those of the above-described third operation pattern.

In step S405, the gNB 200a transmits a message to the gNB 200b to request to obtain the SIB20/MCCH of the cell b on the Xn interface.

In step S406, the gNB 200b transmits the SIB20/MCCH of the cell b to the gNB 200a on the Xn interface.

In step S407, the gNB 200a transmits the SIB20/MCCH that the gNB 200b notified (shared) to the UE 100a by broadcasting or dedicated signalling.

In step S408, the UE 100a obtains the MTCH (MBS broadcast data) from the cell b based on the SIB20/MCCH.

### (4) Other Embodiment

In the above-described embodiments, an example has been described in which an MBS is assumed and the broadcast control information obtained from the cell b by the UE 100a existing in the cell a is the SIB20/MCCH. However, the embodiment is not limited to such broadcast control information for an MBS. For example, the UE 100a existing in the cell a may obtain an SIB other than SIB20 from the cell b. As scenarios other than the MBS, the following scenarios can be considered.
A scenario in which reception resources are optimized by ascertaining resource pool information of other cells on sidelink. In this scenario, the UE 100a existing in the cell a may obtain, from the cell b, an SIB for the sidelink resource pool of the cell b.
A scenario in which slices supported by other cells are desired to be ascertained in RAN slicing. In this scenario, the UE 100a existing in the cell a may obtain, from the cell b, an SIB for the slices supported by the cell b.
A scenario in which, with respect to a Non-Public Network (NPN), it is desired to ascertain whether another cell is compatible with the NPN (whether the cell is public). In this scenario, the UE 100a existing in the cell a may obtain, from the cell b, an SIB regarding whether the cell b is compatible with the NPN.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a mobile termination (MT) of the IAB node.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (5) Supplementary Notes

Features relating to the embodiments described above are described below as supplements.

### Supplementary Note 1

A communication method used in a mobile communication system, the communication method including
transmitting, to a predetermined apparatus by a first user equipment existing in a first cell, a request signal for requesting provision of broadcast control information to be broadcast in a second cell adjacent to the first cell, wherein
the predetermined apparatus is a second user equipment existing in the second cell, a first base station being configured to manage the first cell, or a second base station being configured to manage the second cell.

### Supplementary Note 2

The communication method described in supplementary note 1, further including obtaining, by the first user equipment, the broadcast control information from the second base station while the first user equipment exists in the first cell.

### Supplementary Note 3

The communication method described in supplementary note 1 or 2, wherein the broadcast control information includes on-demand system information broadcast in response to a request from a user equipment.

### Supplementary Note 4

The communication method described in any one of supplementary notes 1 to 3, further including
receiving, by the first user equipment existing in the first cell, a multicast traffic channel (MTCH) of the first cell, wherein
the broadcast control information includes a message transmitted on a multicast control channel (MCCH) of the second cell and/or a system information block indicating a configuration of the MCCH.

### Supplementary Note 5

The communication method described in any one of supplementary notes 1 to 4, wherein the predetermined apparatus is the second user equipment,
the transmitting the request signal includes transmitting the request signal to the second user equipment on sidelink, and
the request signal is a transfer request message for requesting transfer of the broadcast control information.

### Supplementary Note 6

The communication method described in supplementary note 5, further including the steps of:
receiving, by the second user equipment, the broadcast control information of the second cell; and
transferring, by the second user equipment, the broadcast control information to the first user equipment on sidelink in response to receiving the request signal.

### Supplementary Note 7

The communication method described in supplementary note 5 or 6, further including the steps of:
transmitting, by the second user equipment, a discovery message on sidelink, the discovery message including at least one of information on a capability of transferring the broadcast control information or information indicating an MBS service that the second cell provides; and receiving, by the first user equipment, the discovery message.

### Supplementary Note 8

The communication method described in supplementary note 5 or 6, further including transmitting, to the second user equipment by the first user equipment, a query about an MBS service that the second cell provides.

### Supplementary Note 9

The communication method described in any one of supplementary notes 5 to 8, wherein the transfer request message includes information indicating an MBS service of interest to the first user equipment.

### Supplementary Note 10

The communication method described in any one of supplementary notes 5 to 9, wherein the transfer request message includes information identifying a cell of interest to the first user equipment and/or information identifying broadcast information of interest to the first user equipment.

### Supplementary Note 11

The communication method described in any one of supplementary notes 5 to 10, wherein the broadcast control information includes a message transmitted on a multicast control channel (MCCH) of the second cell and/or a system information block indicating a configuration of the MCCH, and
the transfer request message includes information requesting to transfer the message without transferring the system information block.

### Supplementary Note 12

The communication method described in any one of supplementary notes 5 to 11, wherein the broadcast control information includes a system information block indicating a configuration of a multicast control channel (MCCH) of the second cell, the communication method further including:
requesting, by the second user equipment having received the transfer request message, the second cell to transmit the system information block.

### Supplementary Note 13

The communication method described in supplementary note 1, wherein the predetermined apparatus is the second base station, and
the transmitting the request signal includes transmitting the request signal directly to the second base station.

### Supplementary Note 14

The communication method described in supplementary note 13, further including broadcasting, in the first cell, by the first base station, information indicating whether to permit transmission of the request signal to the second cell, wherein
the transmitting the request signal includes transmitting the request signal in response to the information indicating that transmission of the request signal is permitted to the second cell.

### Supplementary Note 15

The communication method described in supplementary note 13 or 14, further including receiving, directly by the first user equipment existing in the first cell, the broadcast control information to be broadcast in the second cell.

### Supplementary Note 16

The communication method described in supplementary note 1, wherein
the predetermined apparatus is the first base station, and
the transmitting the request signal includes transmitting the request signal to the first base station.

### Supplementary Note 17

The communication method described in supplementary note 16, wherein
the request signal is a signal for requesting start of broadcasting of the broadcast control information by the second cell, the communication method further including
receiving, by the first user equipment, the broadcast control information from the second cell.

### Supplementary Note 18

The communication method described in supplementary note 16 or 17, further including requesting, by the first base station having received the request signal, the second base station to start transmission of the broadcast control information.

### Supplementary Note 19

The communication method described in supplementary note 16, wherein
the request signal is a signal for requesting acquisition of the broadcast control information from the second base station via the first base station, the communication method further including
receiving, by the first user equipment, the broadcast control information from the first base station.

### Supplementary Note 20

A user equipment used in a mobile communication system, the user equipment including
a transmitter configured to transmit, to a predetermined apparatus, a request signal for requesting provision of broadcast control information to be broadcast in a second cell adjacent to a first cell when the user equipment exists in the first cell,
wherein the predetermined apparatus is another user equipment existing in the second cell, a first base station being configured to manage the first cell, or a second base station being configured to manage the second cell.

### REFERENCE SIGNS

1: Mobile communication system
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method used in a mobile communication system, the communication method comprising:
transmitting, to a predetermined apparatus by a first user equipment existing in a first cell, a request signal for requesting provision of broadcast control information to be broadcast in a second cell adjacent to the first cell, wherein
the predetermined apparatus is a second user equipment existing in the second cell, a first network node being configured to manage the first cell, or a second network node being configured to manage the second cell.

2. The communication method according to claim 1, further comprising:
obtaining, by the first user equipment, the broadcast control information from the second network node when the first user equipment exists in the first cell.

3. The communication method according to claim 1, wherein the broadcast control information comprises on-demand system information broadcast in response to a request from a user equipment.

4. The communication method according to claim 1, further comprising:
receiving, by the first user equipment existing in the first cell, a multicast traffic channel (MTCH) of the first cell, wherein
the broadcast control information comprises a message transmitted on a multicast control channel (MCCH) of the second cell and/or a system information block indicating a configuration of the MCCH.

5. The communication method according to claim 1, wherein
the predetermined apparatus is the second user equipment,
the transmitting the request signal comprises transmitting the request signal to the second user equipment on sidelink, and
the request signal is a transfer request message for requesting transfer of the broadcast control information.

6. The communication method according to claim 5, further comprising the steps of:
receiving, by the second user equipment, the broadcast control information of the second cell; and
transferring, by the second user equipment, the broadcast control information to the first user equipment on sidelink in response to receiving the request signal.

7. The communication method according to claim 5, further comprising the steps of:
transmitting, by the second user equipment, a discovery message on sidelink, the discovery message comprising at least one of information on a capability of transferring the broadcast control information or information indicating an MBS service that the second cell provides; and
receiving, by the first user equipment, the discovery message.

8. The communication method according to claim 5, further comprising:
transmitting, to the second user equipment by the first user equipment, a query about an MBS service that the second cell provides.

9. The communication method according to claim 5, wherein the transfer request message comprises information indicating an MBS service of interest to the first user equipment.

10. The communication method according to claim 5, wherein the transfer request message comprises information identifying a cell of interest to the first user equipment and/or information identifying broadcast information of interest to the first user equipment.

11. The communication method according to claim 5, wherein
the broadcast control information comprises a message transmitted on a multicast control channel (MCCH) of the second cell and/or a system information block indicating a configuration of the MCCH, and
the transfer request message comprises information requesting to transfer the message without transferring the system information block.

12. The communication method according to claim 5, wherein
the broadcast control information comprises a system information block indicating a configuration of a multicast control channel (MCCH) of the second cell, the communication method further comprising:
requesting, by the second user equipment having received the transfer request message, the second cell to transmit the system information block.

13. The communication method according to claim 1, wherein
the predetermined apparatus is the second network node, and
the transmitting the request signal comprises transmitting the request signal directly to the second network node.

14. The communication method according to claim 13, further comprising:
broadcasting, in the first cell, by the first network node, information indicating whether to permit transmission of the request signal to the second cell, wherein
the transmitting the request signal comprises transmitting the request signal in response to the information indicating that transmission of the request signal is permitted to the second cell.

15. The communication method according to claim 13, further comprising:
receiving, directly by the first user equipment existing in the first cell, the broadcast control information to be broadcast in the second cell.

16. The communication method according to claim 1, wherein
the predetermined apparatus is the first network node, and
the transmitting the request signal comprises transmitting the request signal to the first network node.

17. The communication method according to claim 16, wherein
the request signal is a signal for requesting start of broadcasting of the broadcast control information by the second cell, the communication method further comprising:
receiving, by the first user equipment, the broadcast control information from the second cell.

18. The communication method according to claim 16, further comprising:
requesting, by the first network node having received the request signal, the second network node to start transmission of the broadcast control information.

19. The communication method according to claim 16, wherein
the request signal is a signal for requesting acquisition of the broadcast control information from the second network node via the first network node, the communication method further comprising:
receiving, by the first user equipment, the broadcast control information from the first network node.

20. A user equipment used in a mobile communication system, the user equipment comprising:
a transmitter configured to transmit, to a predetermined apparatus, a request signal for requesting provision of broadcast control information to be broadcast in a second cell adjacent to a first cell when the user equipment exists in the first cell,
wherein the predetermined apparatus is another user equipment existing in the second cell, a first network node being configured to manage the first cell, or a second network node being configured to manage the second cell.
